(19) United States
(12) Patent Application Publication
(10) Pub. No.: US 2005/0069291 A1
(43) Pub. Date: Mar. 31, 2005

(54) Systems and methods for locating a video file

(76) Inventors: James S. Voss, Ft. Collins, CO (US); Jim Owens, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,934

(22) Filed: Sep. 25, 2003

(51) Int. Cl. H04N 5/783

(52) U.S. Cl. 386/69; 386/70

(57) ABSTRACT

Disclosed are systems and methods for locating a video file. In one embodiment, a system and method pertain to identifying a key image, identifying a plurality of video files, and searching the plurality of video files for the key image using an image comparison technology.

### BACKGROUND

Video images are captured more and more frequently using digital technology. These video images are captured most often using digital video cameras or digital still cameras having a “movie” mode functionality. The video images can be stored as digital video files on any number of digital storage devices. Given the continually increasing capacity of digital storage devices, the advancements in digital video compression techniques, and freedom from the physical storage limitations of conventional analog recordings, a user's collection of digital videos can quickly grow into a voluminous library of video files.

A user of digital video files may occasionally extract a still image from a digital video file, for example for printing or for posting images on a web page. Although current digital video technology creates relatively low-resolution images which may not be suitable for image extraction, one manufacturer is developing video cameras that can contemporaneously capture both low-resolution images, and high-resolution images that are more suitable for extraction. Such operation has been described as “multi-mode” operation and can result in video files (i.e. multi-mode image files) that contain embedded high-resolution images. Such multi-mode image files are only one example of a video file format from which a user may extract still images.

At some point after extracting a still image from a video file as a digital image file, a user may come across the digital image file and wish to locate the video file from which the image file was extracted. However, if no naming convention was used to associate the image file with the source video file when the image was extracted, a user may have to watch many video files from his library to visually scan for the image before the desired video file is located. This may take more time than the user is willing to spend, especially if the user has a large video file library and/or lengthy individual video files. In another scenario, a user may have an image that was not extracted from the user's video file library, but which is an image of an object possibly contained in a video file. If the user wanted to search a video library for a video that contains that object, the user would have to again watch the video files in his library while visually scanning for the image before the correct video is located, if indeed such a video exists in the library.

Previous solutions to the above-noted video location problems have relied on expediting the human scanning process outlined above, either by speeding up the playback, or developing other methods for “skimming” the video files. One proposed solution involves the creation of a thumbnail view containing multiple images sampled from a video file at regular time intervals. This thumbnail view can be visually scanned faster than watching the video file in its entirety, allowing the user to find the desired video file more quickly. However, if a user's library of video files is extensive, the process would likely still waste the user's time, even with the thumbnail image scanning. In addition, if a scene in a desired video file is too short, or for some other reason was not sampled during the creation of the thumbnail view, then the technique may fail to find the correct video file.

### SUMMARY OF THE DISCLOSURE

Disclosed are systems and methods for locating a video file. In one embodiment, a system and method pertain to identifying a key image, identifying a plurality of video files, and searching the plurality of video files for the key image using an image comparison technology.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which video files can be located.

FIG. 2 is a block diagram of an embodiment of the computing device shown in FIG. 1.

FIG. 3 is a flow diagram that illustrates an embodiment of operation of a video search manager that is configured to search video files for a given image.

FIG. 4 is a schematic representation of an embodiment of a series of low-resolution and high-resolution images captured with a camera shown in FIG. 1 using a multi-mode operation.

FIG. 5 is a block diagram that illustrates an embodiment of a method for comparing a frame from a video file with a key image.

FIG. 6 is a flow diagram that summarizes an embodiment of a method for locating an image file.

### DETAILED DESCRIPTION

Systems and methods are disclosed herein that automatically search a plurality of video files, such as multi-mode image files, by scanning through the plurality of frames contained within video files for instances of a key image so that the user can find video files containing a desired image. Although particular system and method embodiments are disclosed, these embodiments are provided for purposes of example only to facilitate description of the disclosed systems and methods. Accordingly, other embodiments are possible.

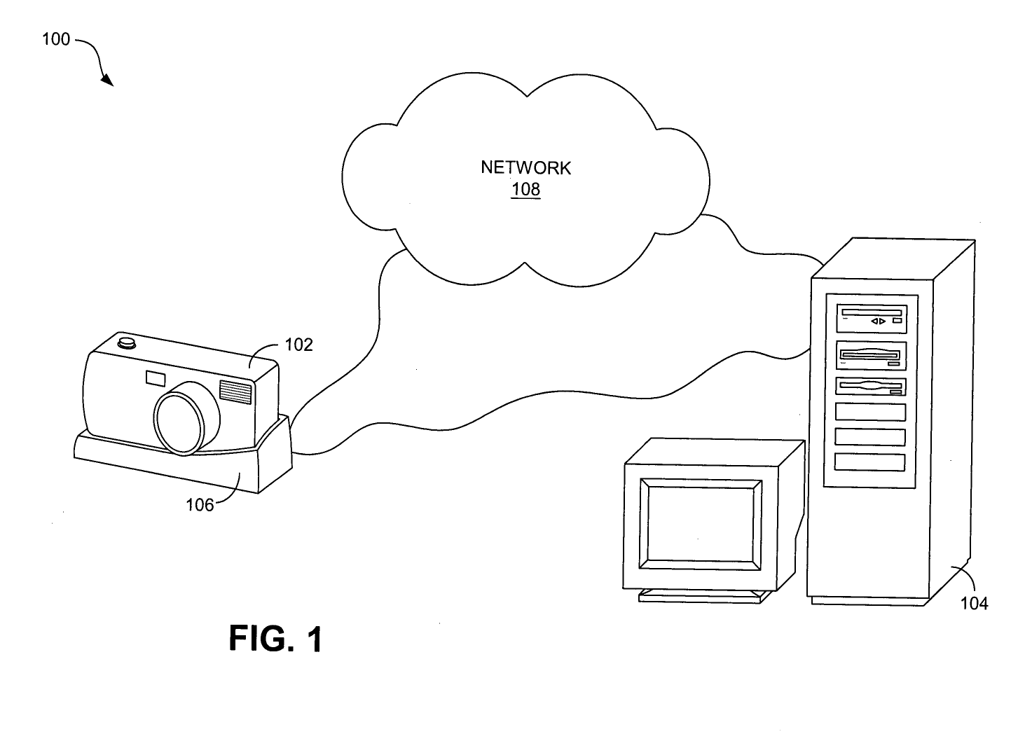

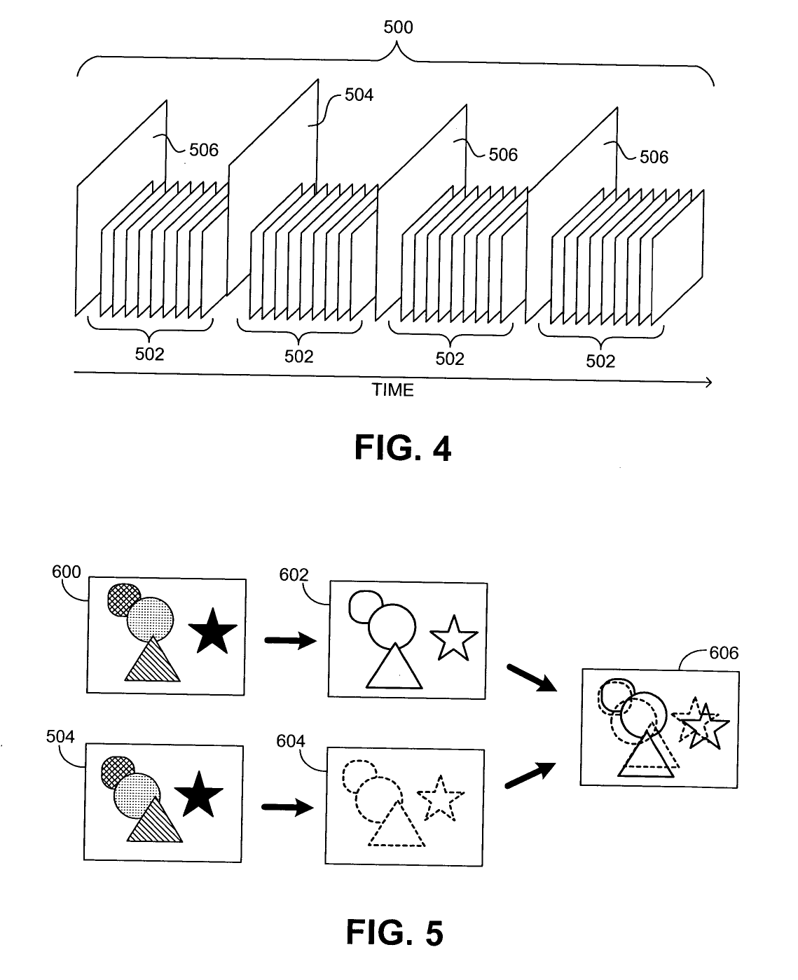

Referring now to the drawings, in which like numerals indicate corresponding parts throughout the several views, FIG. 1 illustrates a system 100 that enables searching of video files for a given image. As indicated in that figure, the example system 100 comprises a camera 102 and a computing device 104 to which video data, such as multi-mode image data, captured with the camera can be downloaded for viewing and/or storage. A discussion of the multi-mode image data and capturing is provided in relation to FIG. 4 below. By way of example, the camera 102 comprises a digital video camera or a digital still camera that is capable of capturing video data, for example in a “movie” mode.

As indicated in FIG. 1, the computing device 104 may comprise a desktop personal computer (PC). Although a PC is shown and has been identified herein, the computing device 104 can comprise substantially any computing device that can communicate with the camera 102 and manipulate image data received therefrom. Accordingly, the computing device 104 could comprise, for example, a workstation, a server, a MacIntosh™ computer, a notebook computer, a tablet computer, a personal digital assistant (PDA), or the like.

The camera 102 can communicate with the computing device 104 in various ways. For instance, the camera 102 can directly connect to the computing device 104 using a docking station 106 on which the camera may be placed. In such a case, the docking station 106 may comprise a cable (e.g., a universal serial bus (USB) cable) that can be plugged into the computing device 104. Alternatively, the camera 102 can indirectly “connect” to the computing device 104, for instance via a local or wide area network 108. The camera's connection to such a network 108 may be via a cable (e.g., a USB cable) or, in some cases, via wireless communication.

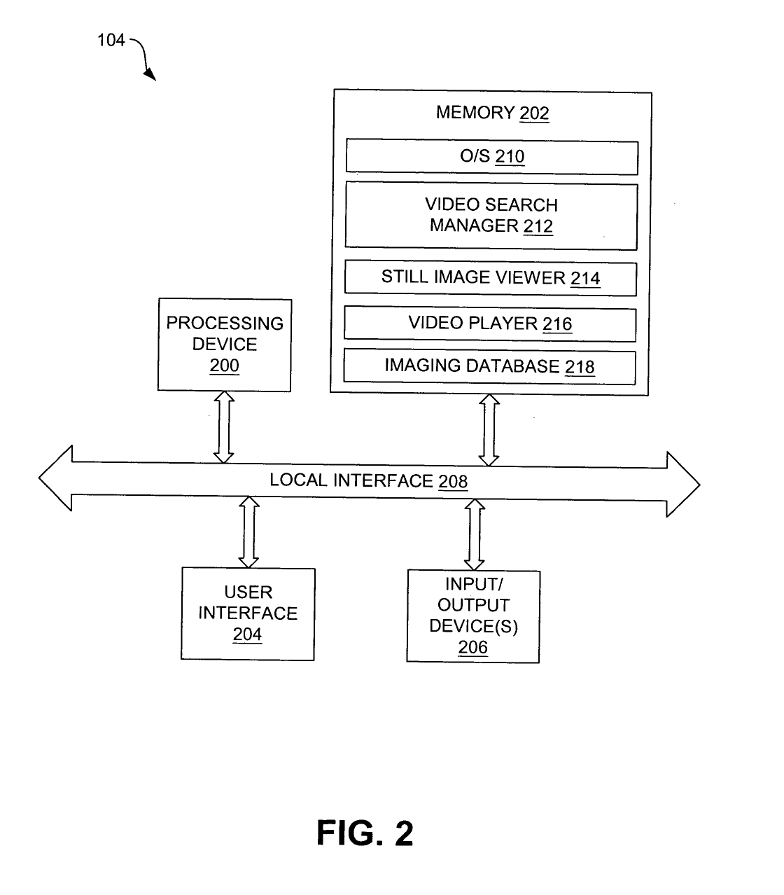

FIG. 2 illustrates an embodiment of the computing device 104 shown in FIG. 1. As indicated in FIG. 2, the computing device 104 comprises a processing device 200, memory 202, a user interface 204, and at least one input/output (I/O) device 206, each of which is connected to a local interface 208.

The processing device 200 can include a central processing unit (CPU) or an auxiliary processor among several processors associated with the computing device 104. The memory 202 includes any one of or a combination of volatile memory elements (e.g., random access memory (RAM)) and nonvolatile memory elements (e.g., read only memory (ROM), Flash memory, hard disk, etc.).

The user interface 204 comprises the components with which a user interacts with the computing device 104, such as a keyboard and mouse, and a device that provides visual information to the user, such as a cathode ray tube (CRT) or liquid crystal display (LCD) monitor.

With further reference to FIG. 2, the one or more I/O devices 206 are configured to facilitate communications with the camera 102 and may include one or more communication components such as a modulator/demodulator (e.g., modem), USB connector, wireless (e.g., radio frequency (RF)) transceiver, a telephonic interface, or a network card.

The memory 202 comprises various programs including an operating system 210 and a video search manager 212. The operating system 210 controls the execution of other software and provides scheduling, I/O control, file and data management, memory management, and communication control, in addition to related services. The video search manager 212 comprises a program (i.e. logic) that is used to search through a library of video files for a particular image so as to facilitate location of a particular video file.

In addition to the above-mentioned components, the memory 202 may comprise a still image viewer 214, and a video player 216. The still image viewer 214 comprises a program with which still image data may be viewed as individual still images, while the video player 216 comprises a program with which video image data can be viewed as streaming video as well as still images. The memory also may comprise an imaging database 218, for instance located on a device hard disk, that is used to store and arrange image data captured by the camera 102 (still image files and/or video files).

Various programs have been described above. These programs can be stored on any computer-readable medium for use by or in connection with any computer-related system or method. In the context of this disclosure, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch instructions from the instruction execution system, apparatus, or device and execute the instructions.

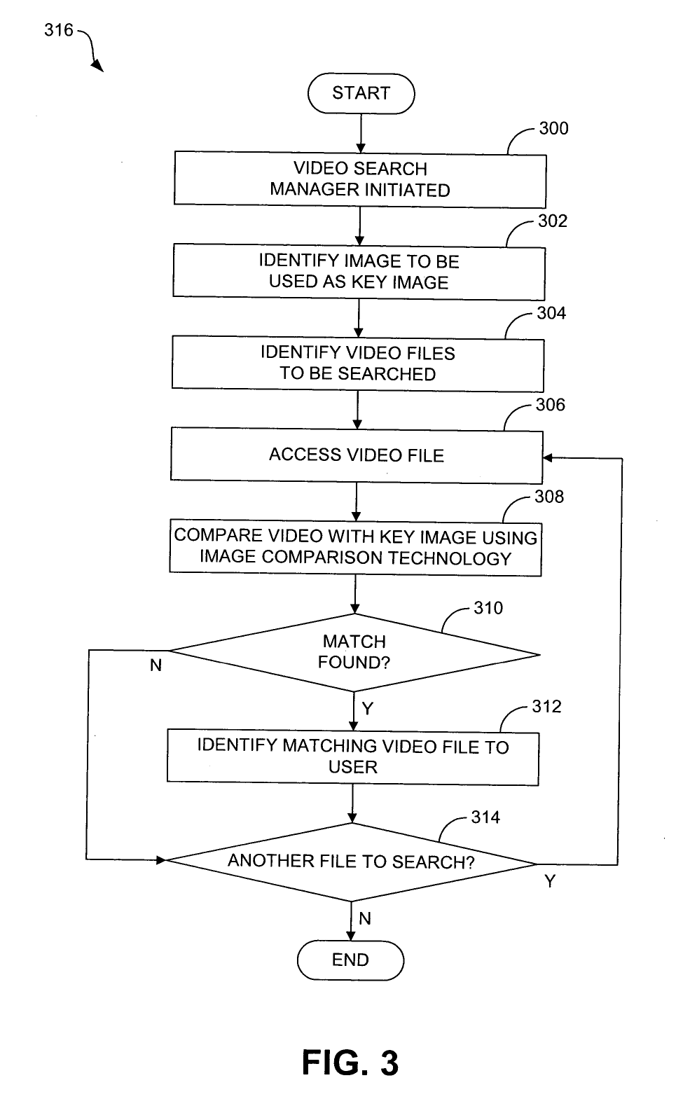

FIG. 3 is a flow diagram that provides an example of operation of the video search manager 212 of the computing device 104. More particularly, FIG. 3 provides an example of the video search manager 212 searching a collection of video files for one or more instances of a key image. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that show or discussed, including substantially concurrently or in reverse order, depending on the functionality involved.

Beginning with block 300, the video search manager 212 is initiated. Such initiation can occur upon the user entering a command to search for a video file among a collection of video files. For example, a command can be entered by the user while reviewing a still image in an image viewer, for example the still image viewer 214 (FIG. 2) to search for a video file that contains that image or an image that includes the same or similar image content. In such a case, the user may have, for example, been viewing images previously extracted from multi-mode image files and may wish to access the particular video file from which it was taken.

The nature with which the “initiate” command is triggered may depend upon the implementation of the video search manager 212. For instance, if the manager 212 comprises a portion of a still image viewer, the command can be presented to the user within the image viewer. In some embodiments, the command may comprise a “Search for Video” button that is presented within the interface of the image viewer. Alternatively, the “initiate” command may be provided in an appropriate menu accessible within the image viewer interface. If, on the other hand, the video search manager 212 is implemented within the operating system (e.g., operating system 210, FIG. 2) and not in a particular program like the image viewer, the initiate command may be implemented through other means. For example, the user may click on the right mouse button on a still image file, causing a contextual pop-up menu to appear, including a “Search for Video” option, which can be clicked with the left mouse button. Notably, any other appropriate means for conveying a desire to search for a particular video file in a collection of video files can be employed.

Regardless of the manner in which the video search manager 212 is initiated, the manager can then identify an image to be used as the key image for searching, as indicated in block 302. This identification may comprise one or more of identifying the identity (e.g., filename), the location (e.g., hard disk location), and the content (e.g., image data when the image has not been saved to a file) of the image. The identification process can be performed in various ways and may depend upon the image data that the user is reviewing. For example, if at the time the video search manager 212 is initiated the user is viewing a high-resolution image previously extracted from a multi-mode image file in an image viewer, the manager identifies the identity and/or location of the image from the image viewer. Similarly, if the user is viewing a list of image files and right clicks on an image file to be searched, the video search manager 212 will be able to identify the identity and location of the file from the operating system 210.

Once the key image has been identified, the video search manager 212 identifies the collection of video files that will be searched for occurrences of the key image, as is represented by block 304. This identification process, similar to that of block 302, may comprise one or both of identifying the identities (e.g., filenames) of individual video files and identifying the locations (e.g., hard disk locations or a directory) of individual or collections of video files. This identification process can be performed in various ways. For example, a user may explicitly identify to the manager 212 the location of a directory that contains a given video file library. Alternatively, the video search manager 212 may already “know” the file extension of the video (e.g., multi-mode image or Motion Picture Experts Group (MPEG) files, and may therefore be configured to automatically search the user's computing device 104 (or other devices on the network 108) for files having that extension.

Once the video search manager 212 has identified both the key image and the collection of video files to be searched, the manager then accesses a video file contained in the collection of video files, as indicated in block 306. The manager 212 can accomplish this access via, for example, a request to the operating system 210 or with the aid of another program such as the video player 216.

Referring next to block 308, the video search manager 212 analyzes the accessed video file by comparing the content of the key image with the content of the video file using an image comparison technology. In one embodiment, the manager 212 may compare the key image to every frame of video in the video file, or just to certain frames, possibly depending on the type of video file being analyzed. For example, if the key image is known to be a high-resolution image previously extracted from a multi-mode image file (e.g., from metadata contained in the image file), then the manager 212 will only need to compare the key image with the high-resolution images stored in the multi-mode image file. More rapid searches may be accomplished, for all types of files, by simply comparing the key image to every nth (e.g., second, third, fourth, etc.) video frame.

To retrieve the individual video frames, the video search manager 212 may, in some embodiments, need to decompress the contents of a compressed video image file. For example, that may be the case with MPEG video files. In another embodiment, the manager 212 may first evaluate color or geometrically-stored image data embedded within the video file before examining the individual frames of video.

When comparing the video frames with the key image, the video search manager 212 may use any one of several image comparison technologies. Some comparison algorithms incorporate pixel-by-pixel comparisons, whereas others match patterns between the images. Suitable image comparison techniques may include, for example, application of a normalization, least squares fitting, correlation, or geometric pattern matching algorithm. Examples of such comparison are provided in relation to FIG. 5 below.

Whether a key image is considered to be a match with a particular target video frame may be controlled by the user. For example, in one embodiment, a user may set a tolerance level for whether the match should be perfect or just close enough. As noted above, the key image may have or may not have been extracted from a video file. In the latter case, individual features of the key image may be used to conduct the comparison and thereby locate a video file that contains content contained within the key image. In such a case, all of the image data of the key image may not be contained in a given video file or frame to have a “match.”

Flow from this point depends on whether the key image matches the video file, as indicated in decision block 310. If a match is found, flow progresses to block 312, where the video search manager 212 identifies the “matching” video file to the user. Optionally, the manager 212 may at that time store the search results and immediately terminate the comparison with the current video file. The stored results may include the identity and location of the video file, as well as the location within the video file where the match was found, for example indicated by a timestamp. At this point, the user is free to watch the video file or manipulate it in any other desired way. Optionally, the user may be provided with the choice to view a given segment of the matching video file, for instance a segment that contains an embedded image that matches the key image. The duration of such segments can be selected by the user. For instance, the user could choose to view a segment that comprises 10 minutes of a 30 minute video clip, with the segment “centered” in time about the location of the embedded image.

Returning to decision block 310, if a match was not found within the current video file, the manager 212 next determines whether there is another video file to search, as indicated by decision block 314. If there are other video files to be searched, then the manager 212 accesses the next video file (block 306) and the comparison process describe above begins anew. If there are no more files to be searched, or alternatively, if the manager 212 is configured to halt after a successful match, then the video search session terminates.

FIG. 4 depicts a series of low-resolution images 502 and high-resolution images 506 as might be stored in a multi-mode image file 500. The video search manager 212 may examine one particular high-resolution image 504 while searching the multi-mode image file 500 for the key image, which may be a high-resolution image previously extracted from a multi-mode image file. As shown in FIG. 4, relatively low-resolution images 502 are sequentially captured using the camera 102. In the example of FIG. 4, nine such images are captured in a row, for instance in a period of about one third of one second (to yield 27 frames per second (fps)). After the last relatively low-resolution image 502 in the given sequence is captured, the camera 102 captures a relatively high-resolution image 506. By way of example, one such relatively high-resolution image 506 can be captured about each third of one second (to yield 3 fps). After a relatively high-resolution image 506 is captured, the process continues with relatively low-resolution images 502 being sequentially captured, a relatively high-resolution image 506 being captured, and so forth as long as the user wishes to capture image data. Therefore, low-resolution images and high-resolution images are captured in the same image capture instance or session (e.g., during a period between which the user starts and stops recording video) and stored in a multi-mode image file. The multi-mode operation depicted in FIG. 4 is described in greater detail in commonly-assigned U.S. patent application Ser. No. 10/068,995 entitled “System and Method for Capturing and Embedding High-Resolution Still Image Data into a Video Stream” and having Attorney Docket No. 10011558-1, filed Feb. 6, 2002, which is hereby incorporated by reference into the present disclosure.

The diagram of FIG. 5 visually depicts an embodiment of use of a mathematical process when comparing a key image 600 with a frame from a video file 504. In order to avoid comparisons involving slight variations in pixel content, the manager 212 may find the edges of objects in both the key image 600 and video frame 504 using geometric edge detection, creating an edge map for the key image 602 and an edge map for the video frame 604. At this point, the edge maps can be compared using pixel-wise mathematics, perhaps creating an overlay 606 of the two. Other algorithms for comparing images have previously been noted.

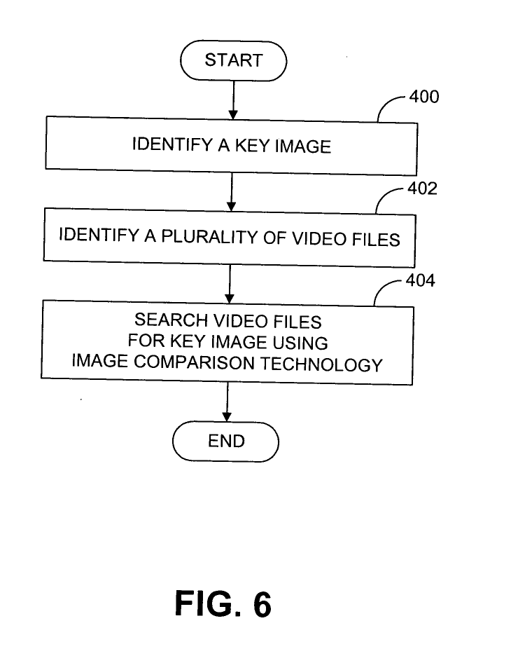

In view of the above disclosure, a method for locating a video file may be summarized as provided in FIG. 6. As indicated in that figure, a key image is identified (block 400), a plurality of video files is identified (block 402), and the video files are searched for the key image using an image comparison technology (block 404).

1. A method for locating a video file, the method comprising:
identifying a key image;
identifying a plurality of video files; and
searching the plurality of video files for a match with the key image using an image comparison technology.

2. The method of claim 1, wherein the key image is contained in a still image file.

3. The method of claim 2, wherein identifying a key image comprises identifying at least one of an identity of the still image file and a location of the still image file.

4. The method of claim 1, wherein the key image was not originally extracted from any of the plurality of video files.

5. The method of claim 1, wherein searching the plurality of video files comprises searching at least one multi-mode image file that comprises low-resolution images and at least one high-resolution image.

6. The method of claim 1, wherein identifying a plurality of video files comprises identifying at least one of an identity of the plurality of video files and a location of a plurality of video files.

7. The method of claim 1, wherein searching comprises executing a pattern matching algorithm.

8. The method of claim 1, wherein searching comprises executing at least one of a normalization algorithm, a correlation algorithm, a geometric pattern matching algorithm, and a least squares fit algorithm.

9. The method of claim 1, further comprising:
identifying a located video file that is a match for the key image to a user.

10. The method of claim 9, further comprising:
identifying at least one timestamp within a video file that indicates a match.

11. A system for locating a video file, the system comprising:
means for identifying a key image;
means for identifying video files to be searched; and
means for automatically comparing the key image to frames of the video files to search for a video file that comprises image content contained in the key image.

12. The system of claim 11, wherein the means for identifying video files comprise means for identifying at least one multi-mode image file that comprises low-resolution images and at least one high-resolution image.

13. The system of claim 11, wherein the means for automatically comparing comprise a pattern-matching algorithm.

14. The system of claim 11, further comprising:
means for identifying a video file that was determined to contain image content that is contained within the key image.

15. A system stored on a computer-readable medium, the system comprising:
logic configured to identify a key image;
logic configured to identify video files to be searched; and
logic configured to compare image content of the key image with content of frames of the video files to locate a video file that contains image content of the key image.

16. The system of claim 15, wherein the logic configured to compare comprises at least one of a normalization algorithm, a correlation algorithm, a geometric pattern matching algorithm, and a least squares fit algorithm.

17. The system of claim 15, wherein the logic configured to compare is configured to compare the key image to at least one high-resolution image of the multi-mode image file.

18. The system of claim 15, further comprising:
logic configured to identify a located video file to a user.

19. The system of claim 18, further comprising:
logic configured to identify at least one timestamp within the located video file, the at least one timestamp indicating a frame within the video file that matches the key image.

20. A video search manager stored on a computer-readable medium and configured for execution by a user computing device, the manager comprising:
logic configured to identify an image that is to be used as a key image in a search for a stored video file;
logic configured to identify a group of stored video files to be searched; and
logic configured to search the group of stored video files to identify at least one video file that contains image content contained within the key image.

21. The manager of claim 20, wherein the logic configured to identify an image comprises logic configured to receive a user's selection of an image being shown to the user.

22. The manager of claim 20, wherein the logic configured to identify a group of video files comprises logic configured to receive a user's selection of the group of video files.

23. The manager of claim 22, wherein the logic configured to receive a user's selection of the group of video files comprises logic configured to receive the user's selection of a directory containing a plurality of video files.

24. The manager of claim 20, wherein the logic configured to identify a group of video files comprises logic configured to receive a user's selection of at least one multi-mode image file that contains both low-resolution images and at least one high-resolution image.

25. The manager of claim 20, wherein the logic configured to search comprises logic to identify at least one video frame of at least one video file that matches the key image.

26. The manager of claim 20, wherein the logic configured to search comprises logic to only search high-resolution images embedded within the stored video files to identify at least one high-resolution image that matches the key image.

27. The manager of claim 20, wherein the logic configured to search comprises logic to identify a feature contained within the key image that is also contained in at least one video frame of at least one video file.
